(19) United States
(12) Patent Application Publication
(10) Pub. No.: US 2002/0121878 A1
(43) Pub. Date: Sep. 5, 2002

(54) Battery cover with components mounted thereon

(76) Inventors: Jan-Olof Svensson, Landskrona (SE); Johan Mercke, Lund (SE)

Correspondence Address: JENKENS & GILCHRIST, PC, 1445 ROSS AVENUE, SUITE 3200, DALLAS, TX, 75202, US

(21) Appl. No.: 09/798,064

(22) Filed: Mar. 2, 2001

(51) Int. Cl. H02J 7/00

(52) U.S. Cl. 320/112

(57) ABSTRACT

A battery pack for a portable device is disclosed. The battery includes a circuit comprising a plurality of circuit components which are connected to each other via a chip on plastic technique thus obviating a need for a circuit carrying substrate such as a printed circuit board. In an alternative embodiment, the battery may be encased by a solid polymer material which can be used as the circuit component connecting means.

### FIELD OF THE INVENTION

This invention relates to battery packs and more particularly, to a method of mounting a plurality of circuit components on a battery pack.

### BACKGROUND OF THE INVENTION

Portable electronic products, such as portable radios, cellular phones, and the like, have become smaller, lighter and include an increasing number of features. Despite these improvements however, the market for these products demands even smaller and lighter designs with even more features. A significant component of a high powered device, such as a cellular phone or a two-way radio transceiver, is the battery used by the device. Battery designs which offer additional functionality are constantly in demand. For example, in the case of lightweight cellular phones, additional functionality such as longer battery life, etc. are heavily touted in marketing campaigns as these feature distinguish one cellular phone from another. Accordingly, any additional features that may be incorporated into a phone, including the battery, which gives a competitive edge in the market place is considered significant.

Many portable electronic products use rechargeable battery packs as a primary power source. These battery packs house one or more energy cells, as well as battery circuitry for controlling the recharging of the battery and for the provision of smart battery functions. The battery circuitry, including associated electrical components, are typically implemented on a circuit carrying substrate such as a printed circuit board (PCB) or flexible film substrate. Generally, the battery packs are housed in a case formed from a rigid material such as plastic or metal. The housing seals and protects the energy cells, the internal battery circuitry, and associated electrical components. Battery contacts, soldered to the circuit carrying substrate, affixed to the housing, or otherwise, provide access to the energy cells and battery functions. It is desirable to be able to offer battery powered portable electronic products with size, weight and longer battery life advantages over competitive products. There are constant efforts to reduce the size and weight of the battery pack while improving or retaining power output capabilities.

### SUMMARY OF THE INVENTION

Accordingly, an object of the present invention is to provide an energy source for portable devices.

A further object of the present invention is to provide an energy source for portable devices which has fewer parts.

A yet another object of the present invention is to provide an energy source for portable devices which is cheaper to manufacture.

Another object of the present invention is to provide an improved electro-static discharge protection.

These and other objects of the present invention are achieved by a novel design for an energy source for portable devices which utilizes advanced mounting techniques and advanced polymers to eliminate the need for the circuit carrying substrates.

### BRIEF DESCRIPTION OF THE DRAWINGS

The above objects and features of the present invention will be more apparent from the following description of the preferred embodiments with reference to the accompanying drawings, wherein:

FIG. 1 illustrates a conventional battery pack/cell;

FIG. 2 illustrates a battery circuit mounted on a battery pack/cell;

FIG. 3a and 3b illustrate a top view and a side view of a battery pack/cell with circuit components mounted thereon according to a first exemplary embodiment of the present invention; and

FIGS. 4a and 4b illustrate a top view and a side view of a battery pack/cell with circuit components mounted according to a second exemplary embodiment of the present invention.

### DETAILED DESCRIPTION OF PREFERRED EMBODIMENTS

In the following description, for purposes of explanation and not limitation, specific details are set forth, such as particular circuits, circuit components, structures, techniques, etc. in order to provide a thorough understanding of the present invention. However, it will be apparent to one skilled in the art that the present invention may be practiced in other embodiments that depart from these specific details. In other instances, detailed descriptions of well-known methods, circuits and structures are omitted so as not to obscure the description of the present invention.

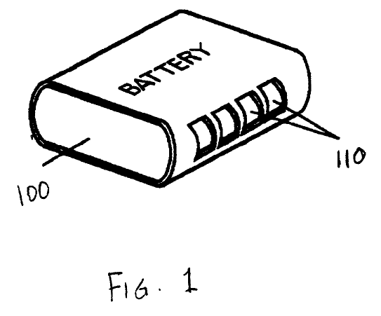

With reference to FIG. 1, a conventional battery pack 100 includes a plurality of contacts 110 which enable the energy stored in the battery to be transferred to a device that relies on the battery 100 for the device operation.

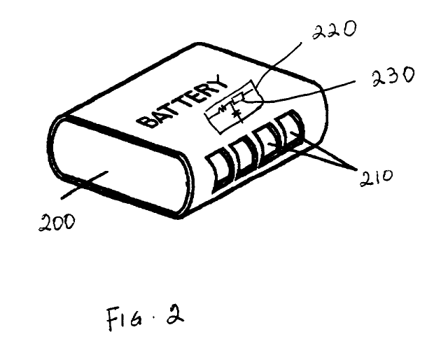

FIG. 2 illustrates a battery circuit mounted on a battery cell/pack 200. The circuit may include a printed circuit board 220 (PCB) having a plurality of components 230 such as resistors, sensors, etc. mounted thereon. The PCB serves the purpose of being a common component carrier.

The battery pack design illustrated in FIG. 2, while adequate, can be improved utilizing novel techniques according to exemplary embodiments of the present invention. More specifically, the battery pack can be redesigned with fewer parts. A decrease in the number of parts has obvious advantages such as reduction in weight and a decrease in cost due to elimination of parts. Other advantages include less maintenance due to fewer parts. These benefits lead to a competitive advantage in the market place to those makers of communication devices that incorporate a battery pack design of the present invention.

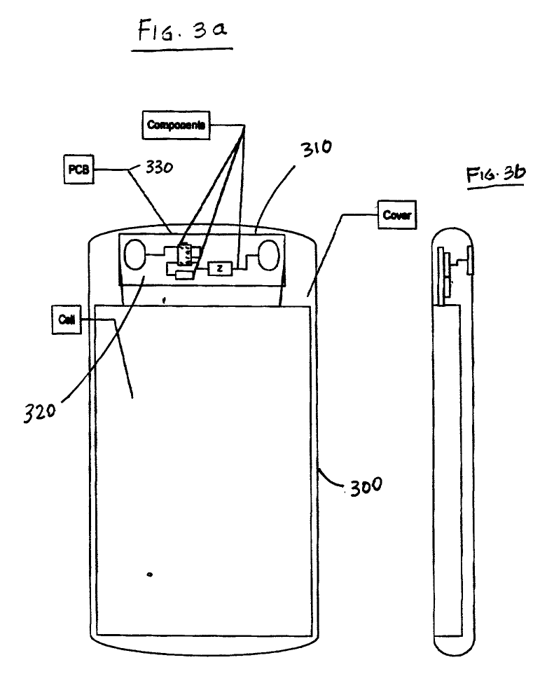

The improved battery design of the present invention is accomplished by the use of new and upcoming manufacturing techniques such as the “chip on plastic” technique for example. With reference to FIG. 3a, an area 310 of a battery pack 300 may be used to house the battery circuit 320. The chip on plastic obviates a need for a component carrier substrate such as a printed circuit board (PCB) 330. The plastic material used for enclosing a battery cell has the capability to function as a circuit carrying substrate through which connections between various components such as resistors can be made. The plastic material may be made conductive by applying a conductive material to the plastic during the screening process. An inner layer of the plastic will be conductive and function as the connecting medium between the components. The plastic material used, therefore, eliminates the need for a separate printed circuit board.

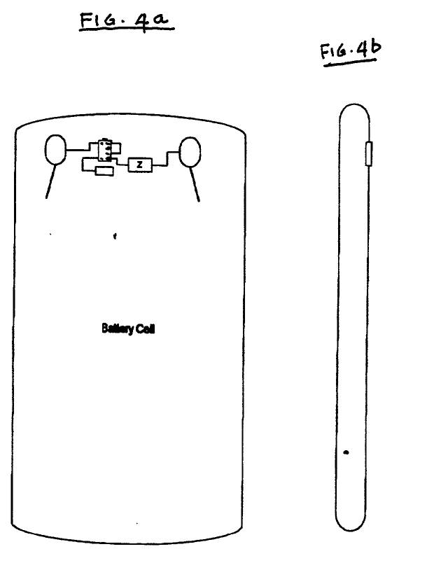

Current advances as well as ongoing developments in solid polymer technology stand to yield the realization to a greater extent, of a battery design according to exemplary embodiments of the present invention. These advances in solid polymer technology have resulted in battery cells being constructed of solid polymers. Therefore, future batteries, made of solid polymers, can have components mounted directly thereon without the need for a common component carrier. Furthermore, a contact area between the battery and a communication device which enables transfer of energy from a battery cell to the device can be made by the surface of the battery pack without an additional component carrier. This is illustrated in FIG. 4a.

By reducing parts such as the PCB, a larger portion of the battery pack may be occupied by the battery cell. A bigger cell provides more energy thus increasing the operating time of a device. Moreover, as the PCB is removed, the number of conductive elements is reduced. This results in an improved electro-static discharge protection for components and the device itself.

The foregoing has described the principles, preferred embodiments and modes of operation of the present invention. However, the invention should not be construed as being limited to the particular embodiments described above. For instance, the battery design of the present invention may be utilized for batteries in a portable devices such as a computer, radio, television or any other devices that rely on battery power. The above-described embodiments should be regarded as illustrative rather than restrictive, and it should be appreciated that variations may be made in those embodiments by those skilled in the art without departing from the scope of the present invention as defined by the following claims.

What is claimed is:

1. A method of manufacturing a battery pack, said method comprising the steps of:
connecting a plurality of circuit components used to monitor battery functions via a conductive plastic medium, said plastic medium providing a common connection surface for the circuit components.

2. The method of claim 1, wherein the plastic material obviates a need for a circuit carrying substrate.

3. A communication device, comprising:
a transmitting means for transmitting information from a user of said communication device;
a receiving means for receiving information by the user;
an antenna means for facilitating communication between the user and a remotely located communication device; and
a battery pack for providing power to operate the communication device and wherein said battery further comprises a plurality of circuit components forming a circuit for monitoring battery functions, said circuit components being connected via a conductive plastic connection medium.

4. The communication device of claim 3, wherein the plastic material obviates a need for a circuit carrying substrate.

5. The communication device of claim 3, wherein said battery functions include monitoring a remaining energy level in the at least one battery cell.

6. The communication device of claim 3, wherein said battery functions include monitoring a temperature of the at least one battery cell.

7. A communication device, comprising:
a transmitting means for transmitting information from a user of said communication device;
a receiving means for receiving information by the user;
an antenna means for facilitating communication between the user and a remotely located communication device; and
an energy means, said energy means further comprising:
at least one battery cell for providing power to operate the communication device;
a solid polymer material casing encompassing said at least one battery cell; and
a plurality of circuit components forming a circuit for monitoring battery functions, said circuit components being connected via said polymer casing.

8. The communication device of claim 7, wherein said battery means further comprises a contact area for facilitating energy transfer from the battery cell to the communication device.

9. The communication device of claim 8, wherein the contact area is located on said casing.
